(19) United States
(12) Patent Application Publication
(10) Pub. No.: US 2007/0028119 A1
(43) Pub. Date: Feb. 1, 2007

(54) Access control system

(76) Inventor: Charles A. Mirho, Vancouver, WA (US)

Correspondence Address: FSP LLC;Attn: Charles A Mirho, P.O. Box 890, Vancouver, WA, 98666, US

(21) Appl. No.: 11/195,193

(22) Filed: Aug. 1, 2005

(51) Int. Cl. G06F 12/14

(52) U.S. Cl. 713/189

(57) ABSTRACT

A system includes logic to authorize ingress to and/or egress from an area or areas at least in part according to contents of the area or areas.

### TECHNICAL FIELD

The present disclosure relates to access control systems.

### BACKGROUND

Access control systems have traditionally controlled who can gain entry to an area or areas. More sophisticated access control could account for complex relationships and interactions among people, objects, and/or devices.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A system may include and/or involve logic to authorize ingress to and/or egress from an area or areas at least in part according to contents of the area or areas. The logic to authorize ingress to and/or egress from an area or areas at least in part according to contents of the area or areas may include and/or involve logic to apply at least some different rules for ingress to the area or areas than for egress from the area or areas, and/or logic to identify devices and/or people in the area or areas, and/or logic to authorize the ingress and/or egress at least in part according to how long at least some of the contents have been in the area or areas, and/or logic to detect the presence of one or more people in the area or areas and to authorize ingress and/or egress at least in part according to whether people are present in the area or area and/or how many, and/or logic to authorize ingress and/or egress at least in part according to organizational roles and/or access rights of one or more people in the area or areas, and/or logic to prevent ingress to and/or egress from the area or areas by an authorized person or persons, when a person or persons unauthorized for ingress and/or egress is proximate to ingress and/or egress points of the area or areas.

The logic to detect the presence of one or more people in the area or areas and to authorize ingress and/or egress at least in part according to whether people are present in the area or area and/or how many may include and/or involve logic to detect one or more heat pattern in the area or areas, and/or logic to detect motion in the area or areas.

A system may include and/or involve logic to control ingress and/or egress to and/or from the area or areas at least in part according to the contents. The logic to control ingress and/or egress to and/or from the area or areas at least in part according to the contents may include and/or involve logic to control at least one of locking, unlocking, opening, or closing a door or doors, and/or logic to control egress from the area or areas at least in part according to which contents have already left the area or areas.

A system may include and/or involve logic to receive communication from one or more wireless identifiers for devices and/or people in the area or areas.

A system may include and/or involve logic to authorize ingress and/or egress from an area or areas at least in part according to activities of one or more people and/or devices in the area or areas.

A system may include and/or involve logic to biometrically identify one or more people in the area or areas. The logic to biometrically identify one or more people in the area or areas may include and/or involve logic to identify by voice the one or more people in the area or areas, and/or logic to apply facial recognition to one or more people in the area or areas.

A system may include and/or involve logic to set access rights for members of an organization to an area or areas of the organization at least in part according to contents of the area or areas.

A system may include and/or involve logic to modify one or more authorizations of a person or persons in the area or areas according to an ingress and/or egress of at least one other person, device, and/or object to or from the area or areas.

A system may include and/or involve logic to actively detect contents of an area or areas, and to update one or more displays proximate to one or more entrances to the area or areas with indications of the contents. The logic to actively detect contents of an area or areas may include and/or involve logic to detect devices and/or people that have entered the area or areas but not yet left the area or areas, and/or logic to update the one or more displays with names and/or titles of people in the area or areas, and/or logic to update the one or more displays with at least one of roles or functions of a person or persons in the area or areas, and/or logic to update the one or more displays with information about at least one function or purpose of one or more devices in the area or areas, and/or logic to update the one or more displays at least in part according to access rights of a person or persons proximate with, approaching, or making contact with an ingress point or points to the area or areas, and/or logic to update the one or more displays at least in part according to access rights of a person or persons proximate with, approaching, or making contact with region or regions proximate to an ingress point or points to the area or areas.

A system may include and/or involve logic to control ingress and/or egress to and/or from the area or areas at least in part according to the contents. The logic to control ingress and/or egress to and/or from the area or areas at least in part according to the contents may include and/or involve logic to control at least one of locking, unlocking, opening, or closing a door or doors, and/or logic to control egress from the area or areas at least in part according to which contents have already left the area or areas. The system may include and/or involve logic to receive communication from one or more wireless identifiers for devices and/or people in the area or areas.

A system may include and/or involve logic to identify a person or persons proximate with, approaching, or making contact with an ingress point or points to the area or areas, or a region or regions proximate thereto. The logic to identify a person or persons proximate with, approaching, or making contact with an ingress point or points to the area or areas, or a region or regions proximate thereto may include and/or involve logic to receive communication from one or more wireless devices carried by the person or persons, and/or logic to authenticate the person or persons, and/or logic to communicate with one or more wireless telephones of the person or persons, and/or logic to identify a person or persons proximate with, approaching, personally contacting, or contacting via a device, a sensor near the ingress point or points, and/or logic to identify the person or persons, or a device thereof, via RFID technology, and/or logic to receive at least one of receive a keyboard input, read a card or badge, receive a voice input, or receive a biometric input from the person or persons. The logic to authenticate the person or persons may include and/or involve logic to vary the manner of authentication, or to forgo authentication, at least in part according to contents of the area or areas, and/or logic to perform facial recognition on the person or persons.

A system may include and/or involve logic to vary the content of the display or displays at least in part according to who is proximate with and/or approaching ingress and/or egress points to the area or areas.

A system may include and/or involve logic to receive at least one selection of the contents of the display and to ascertain whether ingress to the area or areas should be allowed based at least in part on the at least one selection and information about a person or persons providing the at least one selection.

A system may include and/or involve logic to authorize one or more activities for a person or persons in an area or areas, at least in part according to one or more other people and/or devices identified in the area or areas. The logic to authorize one or more activities for a person or persons in an area or areas, at least in part according to one or more other people and/or devices identified in the area or areas may include and/or involve logic to restrict the person or persons to use of particular devices within the area or areas, and/or particular functions of particular devices, and/or logic to restrict activities to at least one sub-area of the area or areas, and/or logic to authorize the person or persons to move and/or remove contents or at least one sub-contents of the area or areas, and/or logic to restrict the person or persons from powering on one or more devices in the area or areas, and/or logic to communicate to one or more devices in the area or areas information about one or more functions of the one or more devices that the person or persons may access, and/or logic to enable at least one device in the area or areas which the person or person is authorized to access, and/or logic to cause at least one device in the area or areas to become disabled if the person or persons become proximate with the device, and/or logic to restrict egress of the person or persons from the area or areas upon detecting unauthorized activity of the person or persons in the area or areas.

The logic to restrict activities to at least one sub-area of the area or areas may include and/or involve logic to monitor a location or locations of the person or persons in the area or areas. The logic to authorize the person or persons to move and/or remove contents or at least one sub-contents of the area or areas may include and/or involve logic to cause a lock-down, and/or to release a lock-down of one or more devices in the area or areas, and/or logic to detect motion and/or removal of at least one object in the area or areas. The logic to cause at least one device in the area or areas to become disabled if the person or persons become proximate with the device may include and/or involve logic to cause the at least one device to become disabled if the person or persons become proximate and no person who is authorized to use the at least one device is not also proximate.

A system may include and/or involve logic to control ingress and/or egress to and/or from the area or areas at least in part according to the contents. The logic to control ingress and/or egress to and/or from the area or areas at least in part according to the contents may include and/or involve logic to control at least one of locking, unlocking, opening, or closing a door or doors, and/or logic to control egress from the area or areas at least in part according to which contents have already left the area or areas.

A system may include and/or involve logic to obtain, from at least one device within the area or areas, authorization information about at least one of people, devices, roles, titles, access levels, or functions that are permitted in the area or areas with the device and/or a person associated therewith. The logic to obtain, from at least one device within the area or areas, authorization information about at least one of people, devices, roles, titles, access levels, or functions that are permitted in the area or areas with the device and/or a person associated therewith may include and/or involve logic to obtain, from one or more computers, controllers, terminals, data processing devices, tools, or equipment in the area or areas, information about which people, roles, titles, access levels, or functions are allowed in the area or area with the one or more computers, controllers, terminals, data processing devices, tools, or equipment.

A system may include and/or involve logic to modify one or more authorizations of a person or persons in the area or areas according to an ingress and/or egress of at least one other person, device, and/or object to or from the area or areas.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of apparatus and arrangements to carry out techniques of access and/or authorization.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

### Apparatus and Arrangements to Carry Out Techniques of Access and/or Authorization

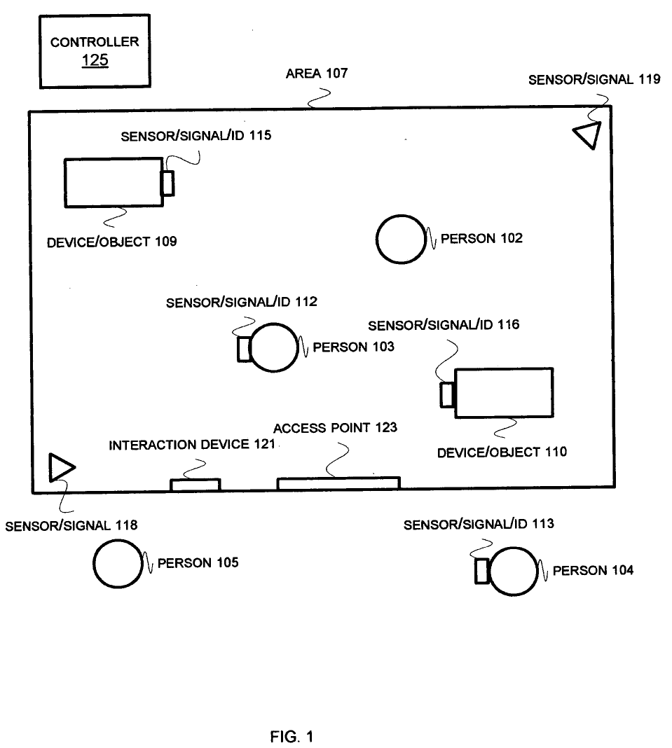

FIG. 1 is a block diagram of an embodiment of a components of various apparatus and arrangements to carry out techniques of access and-or activity control.

The system includes an area 107 with at least one access point 123. The system may include people 102, 103 within the area 107 and also people 104, 105 proximate to the area 107 and/or an access point 123 to and from the area 107. Contents of the area 107 may also include objects and/or devices 109 and 110. The area 107 may further include one or more sensors 118 119. An interaction device 121 may be located proximate to the access point 123. A controller 125 may act to coordinate and/or control various actions of the system.

The access point 123 provides a way for people, devices, and/or objects to move into and out of the area 107. The access point 123 may provide or prevent physical access to or from the area 107. The access point 123 may include states such as open or closed or locked or unlocked. The states may be changed as a result of decisions made by other components of the system, for example, by the controller 125. The access point 123 may interface with other system components, such as a wired or wireless network interface.

The interaction device 121 operates to obtain or accomplish the exchange of information between a person, object, and/or a device, and the system. Examples of an interaction device 121 include a keypad, card reader, RFID reader, digital camera, or biometric sensor such as a fingerprint or retina scanner.

Interaction may occur as a result of proximity. For example, the interaction device 121 may incorporate short-range wireless capabilities that might communicate with something having such capabilities (such as a badge or medallion or tag) on a person, object, or device. Interaction may also occur as a result of activities such as a person entering data on a keypad or providing a biometric input.

The interaction device 121 may communicate obtained information to other system elements. For example, the interaction device 121 may have a network interface. The interaction device 121 may also present information to a user using such output mechanisms as, for example, one or more displays or speakers. The information obtained using the interaction device 121 may be used by other components of the system, for example, by the controller 125.

People outside the area 107 may wish to enter the area 107. People within the area 107 may wish to operate devices and/or access or approach people and/or objects within the area 107. People within the area 107 may wish to leave the area 107.

Some people may carry devices 113 and 112 that serve to facilitate their identification, authentication, location, and/or authorization. These devices 112 113 may obtain, carry, and/or communicate information and incorporate other functions. At least some of the devices 112 113 may include a capability to request information from and communicate information to other system element and/or the people. For example, one or more of the devices 112 113 might include a small display or speaker which it uses to request an individual provide a fingerprint scan, as well as a short-range communication capability which it uses in part to communicate the results of that scan. As a second example of obtaining, carrying, and communicating information, at least some of the devices 112 113 may also carry information on how and/or which of one or more particular devices/objects in the area 107 or areas are to be approached, operated, handled, etc. One or more of the devices 112 113 may display or otherwise communicate this information to other system elements and/or people.

One or more of the device 112 113 may generate and carry a record of a person's entry and/or exit from the area 107 or areas as well as possibly information about their behavior such as their movements within the area 107 or use or proximity to devices/objects of the area 107. Examples of devices 112 113 include smart cards, cell phones, personal digital assistants (pdas), badges and/or wearable items such as watches or rings.

The devices/objects 109 110 may have incorporated or associated devices 115 116 that facilitate identification of the objects/devices 109 110, location of the objects/devices 109 110, and/or authorization of activities involving the objects/devices 109 110 in manners to be described. For example, the associated devices 115 116 may include a short-range communication capability such as an RFID tag that may enable the system to identify the device/object 109 110, authorize activities involving the device/object 109 110, and/or recognize when they device/object 109 110 is being moved. Light beams, mechanical waves such as sound waves, and electronic communications over a wired network may also be used by the devices 109 110.

A person's presence within the area 107 may not automatically mean the person is authorized to use or even approach certain devices/objects/people within the area. The associated device 115 116 may incorporate a feature such as a fingerprint scanner or keypad which can be used to perform authentication and authorization of people trying to use the device. The devices 115 116 may include capabilities to obtain and/or exchange authenticating/authorizing information with devices 112 113 carried by people.

The area 107 may further include one or more sensors 118 119 to facilitate locations, notification, identifications, and so on, in manners to be described. Examples of sensors 118 119 include cameras, microphones, speakers, heat sensors, motion detectors and sensors with short-range wireless communications capability. The sensors may have a capability to communicate the information they collect to other system elements. This capability may comprise wired or wireless communications.

A controller 125 may act to coordinate and/or control various actions of the system. The controller 125 may also provide a central source for authentication and/or authorization information. The controller 125 may comprise one or more computers, storage systems, interfaces, databases, programs, and so on. The elements of the controller 125 may or may not be located in the same location. Elements of the controller 125 may communicate with each other and/or other components of the system using communications capabilities such as wired (e.g. Ethernet) and/or wireless (e.g. Bluetooth, Wi-Fi, Wi-Max ) communications.

### Authorizing Ingress and/or Egress

A system may include and/or involve logic to authorize ingress to and/or egress from an area 107 or areas at least in part according to contents of the area 107 or areas (henceforth, ‘access authorization logic’). The access authorization logic may include and/or involve logic to apply at least some different rules for ingress to the area 107 or areas than for egress from the area or areas 107. For example, egress may be allowed by any individual within an area 107 as long as the state of the area 107 is considered to be acceptable. For example, acceptable might be defined at least in part as no recognized recent activity such as repeated attempts to perform unauthorized actions on a device within the area 107. Acceptable may also mean devices/objects of the area are accounted for. Entry into an area 107 might only be allowed for certain individuals if the individuals can be authenticated, if a supervisory individual is present in or near the area 107 or areas, and/or if the time of day is within the regular working hours of the individuals.

The access authorization logic may also or alternatively include and/or involve logic to identify devices, objects, and/or people 102 103 in the area 107 or areas. Identification may occur, among other ways, by electronic means (such as RFID communication) or by information communicated by a known trusted individual, in other words, by an individual who has been authenticated and is authorized to convey such information.

In some implementations the access authorization logic may also or alternatively include and/or involve logic to authorize the ingress and/or egress at least in part according to how long at least some of the contents have been in the area 107 or areas, and/or logic to detect the presence of one or more people in the area or areas 107 or areas and to authorize ingress and/or egress at least in part according to whether people (either specific ones, or in general) are present in the area 107 or areas and/or how many.

For example, a device might repeatedly be brought to the area 107 or areas to interact with contents which usually remain within the area 107. Once the device is within the area 107, it might begin interacting with the other devices. That interaction might be known to last for an interval of time, such as 15 to 30 minutes. During that interaction, no individuals or other equipment carried by individuals might be allowed in the area 107 (i.e., the interaction is desired to be private). After the interaction is complete, authorized individuals may access the area 107 and remove the device. The system might use short-range wireless communications to determine that the device is in the area 107 (for example, the device may have an RFID tag). The system may record when the device entered, and calculate how long it has been present in the area. If a certain length of time has passed, (consistent with the example, say 45 minutes), or if the device indicates that its interactions are complete, the system may allow access to the area 107 by authorized individuals.

Sensors 118 119 may also be used to ascertain a state of the area. For example, heat sensors may be used to recognize that a source of heat entered the area. The system might recognize this condition as a possible security violation, raise an alarm in a central place, and deny normally authorized individuals ingress to the area 107 while the device is present in the area 107.

The presence and quantity of people within the area 107 may be an important consideration when the area has a finite capacity. The area 107 might for safety reasons be constrained to a certain number of people at any given time. The system may determine how many people are in the area and restrict access accordingly. Another example is when the system determines that all available equipment in the area 107 is already in use. For example, if the area 107 is a training room the logic to allow access might only provide access if there is an available training station within the area 107, i.e., the area 107 is not at maximum capacity.

As another example, certain individuals might be authorized to access the area 107 during the regular working hours whether or not other individuals were present However, at other times, such as on a weekend when the certain individuals were not expected to work, ingress might only be granted if someone else (such as a supervisor) were already in the area 107.

There may be various manners of implementing the access authorization logic, including but not limited to providing logic to authorize ingress and/or egress at least in part according to organizational roles and/or access rights of one or more people in or proximate to the area 107 or areas. For example, certain people may only be authorized for ingress if a supervisor or administrator is already in the area 107 or proximate thereto.

In some implementations the access authorization logic may also or alternatively include and/or involve logic to prevent ingress to and/or egress from the area 107 or areas by an authorized person or persons, when a person or persons unauthorized for ingress and/or egress is proximate to ingress and/or egress points 123 of the area 107 or areas. For example, if person 104 is authenticated and would be authorized for access, but person 105 proximate to 104 near the access point 123 cannot be authenticated satisfactorily, person 104 may not be authorized and both individuals 104 105 may thus be unable to enter the area 107. Such a technique may be employed to prevent “tailgating” into the area 107 by unauthorized individuals.

The logic to detect the presence of one or more people in the area 107 or areas and to authorize ingress and/or egress at least in part according to whether people are present in the area 107 or area and/or how many (henceforth, ‘presence detection and authorization logic’) may include and/or involve logic to detect one or more heat pattern in the area 107 or areas. For example, sensors 118 119 in the area 107 may recognize some number of distinct, moving sources of heat consistent in characteristics with individuals. Another manner of implementing the presence detection and authorization logic may include and/or involve logic to detect motion in the area 107 or areas.

People may carry cellular telephones that may be employed to facilitate identification/authorization of the people. For example, may cellular telephones comprise unique device identifications and/or personal identifications (e.g. SIM cards, manufacturing ids, or other identifying logic). The identifying/authorizing information of a cellular telephone may be accessible directly from the phone, or via the cellular network that services the phone. At least some of this information may be accessed and applied to facilitate ingress/egress decisions, to identify the presence of people in or near an area 107 or areas, and/or to identify authorized activities of a person in the area 107 or areas.

The system may include and/or involve logic to control ingress and/or egress to and/or from the area 107 or areas at least in part according to the contents, e.g. people, objects, and/or devices in the area (henceforth, ‘access control logic’). The access control logic may include and/or involve logic to control at least one of locking, unlocking, opening, or closing a door or doors. One manner of implementing access control logic may include and/or involve logic to control egress from the area 107 or areas at least in part according to which contents (people, device, and/or objects) have already left the area 107 or areas. For example, egress may be denied to an individual recognized as moving a device 109 to the access/exit point 123 if no supervisory individual is currently in and/or proximate to the area 107 and/or access point 123.

Individuals and/or devices/objects might be identified using wireless communications. Individuals might have to provide identification information (such as a user id and password or a biometric input) in order to be granted egress. In some cases, the system may use sensors 118 119 such as heat or motion sensors or cameras, and associated logic, to determine that some device or some individual is leaving the area 107, without determining which one.

To determine contents of the area 107 or areas, the system may include and/or involve logic to receive communication from one or more wireless identifiers for objects, devices, and/or people in or proximate to the area 107 or areas. In some embodiments, if the system authenticates a person or device when they are proximate, i.e., at their time of entry into the area 107, it may assume they continue to be present in the area 107, at least subject to some qualifications, such as for a limited duration of time. In such a case, the system may periodically validate that the assumed person or device is still present by some means, such as via wireless communications, voice analysis of conversation in the area, facial analysis, or using sensors 118 119. Devices 112 113 carried by a person or persons may include RFID tags incorporated into a wearable item such as a badge, medallion, or ring. Other means for such communication may include the communication capabilities of a device 112 113 carried by a person, such as the voice and/or data communication capabilities of a cell phone or pda. In some situations, components of the system and the device 1 12 113 may cooperate to solicit information from an individual 102-105, such as a biometric input like a fingerprint scan, which can then be used to authenticate that the individual carrying the identifying object 112 113 is who is expected to be carrying it.

The system may include and/or involve logic to authorize ingress and/or egress from an area 107 or areas at least in part according to activities of one or more people and/or devices in the area or areas. More detail on authorization of this type may be found in the section entitled “Authorizing Activities”.

The system may include and/or involve logic to biometrically authenticate—i.e., identify—one or more people in or proximate to the area 107 or areas (henceforth, ‘biometric identification logic’). The biometric identification logic may include and/or involve logic to identify by voice the one or more people in the area 107 or areas. Voice identification may include a challenge—response component. For example, rather than always expecting the individual to say a particular phrase, which could then be pre-recorded by some other unauthorized individual, the system may ask the individual providing the voice identification to say words put together in random order. Voice identification may also include requesting that the individual provide some response which may be expected to be known only to them, such as a password. Voice identification may or may not include the processing of the voice sounds provided into recognized words.

In some implementations the biometric identification logic may also or alternatively include and/or involve logic to apply facial recognition to one or more people in the area or areas. Other biometric identification options include retina scans, hand profile, and fingerprint scans.

The system may include and/or involve logic to set access rights for members of an organization to an area 107 or areas of the organization at least in part according to contents of the area 107 or areas. In other words, as area contents change the system may analyze and change the access rights of the people and things that might be expected to enter/leave via the access point 123. This may occur even if these people or things are not currently proximate to the access point 123. For example, an important person may enter the area 107. To protect that person, access rights for other people who normally have access to the area may then be updated to a state where they are not authorized for entry into the area. This may occur by updating the access rights of these people within a central database. Access determination of a person may include examination of some variable, such as a general access default state; and that variable, which may be used by the system to ultimately grant or deny access for many people or other things regardless of their other authorization status, may be set to a “deny” state. The setting of such a global (applicable to several or all people) variable might be done automatically by the system as a result of processing which occurs on persons ingress. Or, the variable could be manually set by some authorized person. One reason for updating access rights within a data base rather than waiting for people to appear proximate to the access point 123 to calculate their access would be so that other people, such as a security service, could determine that access would be granted or denied appropriately prior to the situation arising. The system may incorporate a feature where a “would this person get access” can be queried to determine if some individual, if they appeared, would at the current time be granted access. A similar system feature might report who would be granted access at the current time. The system may also provide features where, respective of calculations, access status can be overridden within a database or at the current moment by authorized individuals.

The various embodiments of the system may accommodate many options for granting and denying and tracking access rights. Such options may include calculations based at least in part on the current contents of the area 107, and/or on the time of day or date, and/or the people proximate to the area 107, and/or the people expected to soon enter the area 107, and/or what the current contents are doing (for example what functions the devices in the area are currently performing), etc.

The system may include and/or involve logic to modify one or more authorizations of a person or persons in the area or areas according to an ingress and/or egress of at least one other person, device, and/or object to or from the area or areas. For example, person 103 may be in area 107 when an important person enters. Person 103 may then be asked to leave using some communication capability of the system. For example, if person 103 is known by the system to be carrying a cellular telephone (such as device 112), the system may call him 103 up on the cellular phone and inform him that he is expected to leave. Or, if person 103 is using one or more of the devices 109 110 within the area, that information may be conveyed to the one or more devices 109 110 by the system and the device(s) 109 110 may then convey it in some manner, such as through its display if present, to the person 103. As a third option, if the system sensors 118 119 include a speaker, that information may be conveyed using the speaker.

A person or persons may be granted access to area 107 and may be granted access to use of the certain devices in the area 107 because another person is present. The other may then exit the area 107. The se of the devices may then no longer be authorized for remaining person, and that person may be asked to “sign off” or terminate such use and leave. The system and/or the area contents, in this case the system and the device or devices in use, may interact to assure that such termination of use occurs. For example, if the system detects that the user is still apparently using the device(s), it may power the equipment down or lock the interface from use.

Usage rights for one or more devices/objects within the area 107 may be known to the system. Some logical components of the system, including part or all of its authentication and authorization processing, may be used for equipment usage control. In some embodiments, people may interact with objects/devices within the area 107 to obtain usage authorization.

### Display of Contents

A system may include and/or involve logic to actively detect contents of an area 107 or areas (henceforth, ‘content detection logic’), and to update one or more displays proximate to one or more access points 123 to the area 107 or areas with indications of the contents (henceforth, ‘display update logic’). Content detection occur in various fashions, for example as described elsewhere herein.

In one situation, sensors 118 119 may be used to detect the presence of people and/or objects in the area 107 emitting heat. Content detection logic may include logic to analysis the nature of the emitting object by examining factors such as the probable emitting temperature, the total quantity of emitted heat, whether the emitting object is moving, and so on. Based on factors such as these and possibly other factors, the logic may conclude with some level of certainty that a person or electronic object is emitting the heat. In some situations, the system may know, due to authentication logic, who or what has entered the area 107. That person, object, or device may then be tracked using the sensors 118 119. Thus, although sensors 118 119 alone may not be used to identify a person, knowledge of who or what a heat source was at a known position and point of time may be used in conjunction with heat sensing to track a particular person or device as they move about the area 107.

Information about the location and behavior of people, devices, and/or objects may alternatively or also be reported to the system by devices such as the devices 109 110 in the area 107. For example, a device such as 109 which may normally be present in the area 107 (such as a computer system with display and attached printer with a network connection) may report to the system that a particular person is using it.

In some situations, information from one or more sources such as described above may be supplemented by or replaced, at least in part, by information entered into the system directly or indirectly by a trusted source such as an authenticated, authorized individual or another system.

The display update logic may include and/or involve logic to update the one or more displays with names and/or titles of people in the area 107 or areas. The display update logic may also or alternatively include and/or involve logic to update the one or more displays with at least one of roles or functions of a person or persons in the area 107 or areas. This may include and/or involve logic to update the one or more displays with information about at least one function or purpose of one or more devices in the area 107 or areas. There may be various manners of implementing the display update logic, including but not limited to logic to update the one or more displays at least in part according to access rights of a person or persons proximate with, approaching, or making contact with an ingress point or points 123 and/or one or more interaction devices 121 to the area 107 or areas. One manner of implementing the display update logic may include and/or involve providing logic to update the one or more displays. at least in part according to access rights of a person or persons proximate with, approaching, or making contact with a region or regions proximate to an ingress point or points 123 to the area 107 or areas. An example of such a region may be an interaction device 121 such as a card reader, touch pad, biometric device, proximate sensor, and so on.

The system may include and/or involve logic to control ingress and/or egress to and/or from the area 107 or areas at least in part according to the contents of the area 107 or areas (for more details, see the section “Authorizing Ingress and/or Egress”). As previously described, the access control logic may include and/or involve logic to control at least one of locking, unlocking, opening, or closing a door or doors. In some implementations the access control logic may also or alternatively include and/or involve logic to control egress from the area or areas at least in part according to which contents have already left the area or areas.

In order to actively identify contents of the area 107 or areas, the system may include and/or involve logic to receive communication from one or more identifiers for objects, devices, and/or people in the area 107 or areas.

The system may include and/or involve logic to identify a person or persons proximate with, approaching, or making contact with an ingress point or points 123 to the area 107 or areas, or a region or regions proximate thereto 121 (henceforth, ‘person identification logic’). The person identification logic may include and/or involve logic to receive communication from one or more wireless devices carried by the person 104 or persons. The person identification logic may also or alternatively include and/or involve logic to authenticate the person or persons.

Some embodiments implementing person identification logic may utilize one or more sensors (not shown) near the ingress point or points 123. Such systems may include and/or involve logic to identify the person or persons, or a device or object carried thereby, via RFID or other wireless technology. In some implementations the person identification logic may also or alternatively include and/or involve logic to receive at least one of a keyboard input, input from a card or badge, a voice input, or some other form of biometric input from the person or persons. The logic to authenticate the person or persons (henceforth, ‘person authentication logic’) may include and/or involve logic to vary the manner of authentication, or to forgo authentication, at least in part according to contents of the area 107 or areas. The person authentication logic may also or alternatively include and/or involve logic to perform facial recognition on the person or persons.

Some embodiments may include and/or involve logic to communicate with one or more wireless telephones (such as device 113) of person or persons in or near the area 107 or areas. The display contents, which may include information about contents of the area 107 or areas), may be provided on a display of a person's wireless telephone device. A wireless phone may additionally or alternatively be accessed to provide authentication/authorization information, either through its keypad or via a SIM card or biometric input; the cell phone could thus act as both display and authentication/authorization device. Similar display and/or authentication/authorization functions may also be available via a wireless-enabled PDA, smart card, etc. Communication may occur via SMS, EMS, MMS, or other data-band cell phone technology (as opposed to voice-band communication techniques, which may also or alternatively be employed).

The system may include and/or involve logic to vary the content of the display or displays at least in part according to who is proximate with and/or approaching ingress and/or egress points to the area 107 or areas. For example, the system may only provide information about area contents and device capabilities that a person or persons are authorized to know about or use. Thus a person who is only authorized to use the device 110 in a particular manner may only be told about the presence of the device 110 and its ability to perform in the particular manner. A person having broad authorization rights might see a display showing all people and devices/objects within the area 107 or areas, and all of their possible uses. In some embodiments, person's having lesser authorization rights also proximate to the display (such as person 104 in our example) may result in other proximate persons (such as 105) not receiving all the information they would otherwise receive on the display. This would occur to keep the lesser authorized person from seeing more than they should.

The system may include and/or involve logic to receive at least one selection of the contents of the display and to ascertain whether ingress to the area or areas should be allowed based at least in part on the at least one selection and information about a person or persons providing the at least one selection. For example, in some embodiments, the system may show all or some of the system contents on the display, such as all objects/devices within the area 107 along with their possible uses. A person proximate to the display may make one or more selections of objects/device and/or uses from the display. The system may then determine if the area contents, possibly including people in the area, are such that the individual should be allowed to access the area 107 for the purpose of using the selected device(s) in the selected manner(s). In some situations, the system may allow access, but limit some uses either by turning off or otherwise securing some or all functions of some or all of the area contents. In some situations, the system may announce a person or persons attempting to enter and may also announce their intended use(s) of area contents. The system may then interact with one or more people currently in the area 107 before determining if access should be granted.

### Authorizing Activities

A system may include and/or involve logic to authorize one or more activities for a person or persons in an area or areas, at least in part according to one or more other people and/or objects/devices identified in the area or areas (henceforth, ‘activity authorization logic’). The activity authorization logic may include and/or involve logic to restrict the person or persons to use of particular devices within the area 107 or areas, and/or to restrict use to particular functions of particular devices. For example, the area 107 may represent a secured room contained various electronic infrastructure equipment such as servers and network access points for the infrastructure network. An example of a network access point is a receptacle into which an Ethernet communications interface may be plugged. A person having a job function of communications network monitor may be authorized for entry into the area 107 when equipment he uses in the performance of his job, such as network monitoring equipment is present in the area 107. When given access to the room, the person may be restricted to activities performed with the network monitoring equipment 110 but may not be authorized to use a database server in the same area 107. The database server 109 may be considered to contain sensitive information, such that physical access to it is not given to unauthorized people such as person when they cannot be supervised by an authorized person. Because of the presence of the database server in the area 107, the communications network monitor person may only be authorized to access the area 107 and thus use the network monitor when another person with supervising authority such as person is also in the area 107.

The activity authorization logic may also or alternatively include and/or involve logic to restrict person or persons from powering on one or more devices in the area 107 or areas, and/or involve logic to restrict activities to at least one sub-area of the area 107 or areas. For example, the area 107 may represent an equipment area for a media also known as a presentation room to which any student enrolled in a university's college of engineering may go. Within the equipment area 107 there may be a rather complex maze of recording equipment, switches leading from media servers, DVD players, and the like to equipment providing the presentations (possibly located in the presentation room itself) such as TVs and other displays, and so on. As different presentations are hosted by different members of the college staff, many people may be authorized to enter the equipment area 107. However, only a few individuals may have authority to power on or off the equipment located within the room. This would be true because the media servers may be serving multiple video streams at once to various locations, some of the other players may lose their settings and revert to undesirable defaults after a power off, it is too complicated for many of the presentation hosts to figure out why something is not working in the maze of equipment because there is a powered off state in some components within it, and so on.

In some situations a person authorized to enter an area 107 may be authorized to perform activities on several of the devices within the area 107, but may only be authorized to power on or off a subset of these devices. An example may occur if area 107 is a communications equipment closet (typically a small secured room) within a business. The area 107 may contain both communications routers and one or more network monitors. A person having network management responsibilities may under some circumstances be authorized to enter the area 107 and perform some actions on one or more routers and network monitors. The person may only be authorized to power off or on the network monitors.

In this example, if the area 107 contains in one half of its space rack-mounted communications equipment and in the other half a server farm (not numbered), the person 102 may be authorized to enter area 107 but may be restricted to activities within the communications equipment sub-area.

The activity authorization logic may also include and/or involve logic to authorize the person or persons to move and/or remove contents or at least one sub-contents (one or more objects and/or devices making up less than all of the contents) of the area 107 or areas. For example, in the examples provided where a network monitor is part of equipment within an area 107, a person may be authorized to move or remove that particular equipment, but nothing else.

Some implementations of the activity authorization logic may include and/or involve logic to communicate to one or more devices in the area 107 or areas information about one or more functions of the one or more devices that a person or persons may access, and/or logic to enable at least one device in the area 107 or areas which the person or person is authorized to access. For example, the area 107 may contain a database server farm for a system performing highly sensitive financial functions. An individual may be authorized to enter the area 107 and use a particular server. All of the keyboard and display functions of all servers may be electronically controllable via a switch which the access system can control. All keyboard and display functions for all servers in the server farm may normally be set as disabled so that a person having physical access to the area 107 cannot undesirably access the servers. When an individual is given access to area 107 for the purpose of using a server, the system may also interact with the keyboard/ display switch with the result that the keyboard and display for the server are enabled. The system may also interact with the server to convey information about the person 104 who will be accessing it, such that server may also perform authentication and authorization activities validating that the server user is in fact the intended person.

In some cases, the system may perform its authentication and/or authorization logic using, at least in part, the information and capabilities stored on a target device (in our example, a server). The system may communicate with the server to obtain information as to whether or not the person desiring to enter the area 107 is authorized to use the server; and if so, possibly depending on other factors (such as who else is in the area, the day, time of day, etc.), the system may enable access to the area 107.

In some implementations the activity authorization logic may also or alternatively include and/or involve logic to cause at least one device in the area 107 or areas to become disabled if a person or persons without access permission to the device(s) enters the area 107 or becomes proximate with the device(s). As before, an example is the area 107 having a sub-area containing communications infrastructure equipment and a second sub-area containing a server farm. As before, a person may be using the display and keyboard associated with server 109. A communications technician may also be in the communications sub-area. If the communications technician walks over to where person is working, the access system may temporarily disable the display and keyboard for the server. This may occur directly through the switch that was described in the example. Or, it may occur as a result of a communications interaction between the access system and the server whereby the access system informs the server of a security alert condition. Recognition that the technician had entered a sub-area from which he was restricted may occur by several means, including monitoring of RFID tags incorporated in a badge or some other wearable item, use of heat or motion sensors (or even pressure sensors incorporated in the floor), information obtained from security cameras, and so on.

The activity authorization logic may include and/or involve logic to restrict egress of a person or persons from the area 107 or areas upon detecting unauthorized activity of the person or persons in the area 107 or areas (henceforth, ‘activity restriction logic’). For example, in the example above, where a person is a database administrator and does not have permission to move a network monitor, if the person enters the communications sub-area from which he is restricted and moves the network monitor to the ingress/egress point 123, the point 123 may be kept in a locked state and he may not be allowed egress. Other events may also occur at the same time, such as issuing a security alert to some central monitoring location, logging the security alert event, communicating with the person using a sensor/output device such as 118 119, and so on.

The activity restriction logic may include and/or involve logic to monitor a location or locations of the person or persons in the area 107 or areas. Cameras, heat sensors, motion detectors, pressure sensors, RFID, and GPS are some examples of devices that may help accomplish this. The activity restriction logic may include logic to authorize a person or persons to move and/or remove contents or at least one sub-contents of the area 107 or areas (henceforth, ‘mobility authorization logic’) and may include and/or involve logic to cause a lock-down, and/or to release a lock-down of one or more objects and/or devices in the area 107 or areas. For example, sensitive devices within the area 107 such as laptop computers may be situated such that they are physically locked by some electronically controllable equipment in their position. The access system may recognize that the person accessing the area 107 has permission to move that equipment, and may unlock it such that it may be moved for the duration of a person's use of area 107. In some situations, the equipment may only be unlocked if a person initially identified moving as an action he intended to perform when he was granted access to area 107.

Some implementations of the mobility authorization logic may include and/or involve logic to detect motion and/or removal of at least one object in the area 107 or areas. Equipment within the area 107, such as the laptop network monitor in the example just given, may incorporate sensors, such as a motion sensor, which may communicate with the access system when motion is detected. The various sensors, such as heat, motion, and camera, can be used individually or together to identify objects that are moving and/or being removed. In some situations, the system may only recognize that an objective is removed by its absence. For example, the system may periodically attempt to communicate with each of the objects it believes to be in the area 107, and, in this manner, detect that one or more has been removed.

The activity restriction logic may include and/or involve logic to cause at least one device in the area 107 or areas to become disabled if the person or persons become proximate with the device (henceforth, ‘enable/disable logic’), and may include and/or involve logic to cause the at least one device to become disabled if the person or persons become proximate and no person who is authorized to use the at least one device is not also proximate. In this situation, the system recognizes that at least one person such as the communications technician discussed before is proximate with a device) he is not authorized to operate, and will disable the device (e.g. power down) or some use thereof (disabling the keyboard and display, for example) but only if no authorized person is present.

The system may include and/or involve logic to obtain, from at least one device within the area 107 or areas, authorization information about at least one of people, devices, roles, titles, access levels, or functions that are permitted in the area 107 or areas with the device and/or a person associated therewith (henceforth, ‘authorization acquisition logic’). As discussed in a previous example, the system may use logic and information, at least in part, which is contained within one or more of the devices within the area 107 to determine which people and/or functions and/or other refining information pertains for authorization of access and/or use for that one or more devices and/or other devices within the area 107. The authorization acquisition logic may include and/or involve logic to obtain, from one or more computers, controllers, terminals, data processing devices, tools, or equipment in the area 107 or areas, information about which people, roles, titles, access levels, or functions are allowed in the area 107 or area with the one or more computers, controllers, terminals, data processing devices, tools, or equipment. For example, the system may require a person desiring access to an area 107 to identify which equipment and for what uses. In some cases, the system will present the person with a list of potential actions, based on what people and/or objects are within the area 107, and the person may then select what he wishes to do if granted access to the area 107. Based at least in part on that information, the system may interact with the selected target equipment (or people) and obtain authentication information that may be used in the determination to grant or deny ingress.

The system may include and/or involve logic to modify one or more authorizations of a person or persons in the area 107 or areas according to an ingress and/or egress of at least one other person, device, and/or object to or from the area 107 or areas. As given in a previous example, a person may have authority to be in an area and/or to use equipment within an area based at least in part on the presence or absence of other individuals. When the other individuals in the area 107 change, either by new people entering or an occupant leaving, the authorizations associated with each person currently in the area 107 may also change, depending on the totality of current individuals in an area 107 and, in some cases, on their locations within an area. The change in authorizations may include either additional permitted uses for equipment within the area 107, or a revocation of some permitted uses on one or more devices/objects. The change in authorization can result in a person no longer being authorized to occupy an area, or in a person previously denied access to an area or sub-area now being authorized for entry into that area. In some cases, other authorization conditions, such as time of day, some impending event (arrival of an important person is now imminent, for example) or the initiation of ceasing of some activity within the area 107 (running sensitive programs, for example) may also be factors in changing authorization.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A system comprising:
logic to authorize ingress to and/or egress from an area or areas at least in part according to contents of the area or areas.

2. The system of claim 1, wherein the logic to authorize ingress to and/or egress from an area or areas at least in part according to contents of the area or areas further comprises:
logic to detect the presence of one or more people in the area or areas and to authorize ingress and/or egress at least in part according to whether people are present in the area or area and/or how many.

3. The system of claim 1, wherein the logic to authorize ingress to and/or egress from an area or areas at least in part according to contents of the area or areas further comprises:
logic to authorize ingress and/or egress at least in part according to organizational roles and/or access rights of one or more people in the area or areas.

4. The system of claim 1, further comprising:
logic to authorize ingress and/or egress from an area or areas at least in part according to activities of one or more people and/or devices in the area or areas.

5. The system of claim 1, further comprising:
logic to set access rights for members of an organization to an area or areas of the organization at least in part according to contents of the area or areas.

6. The system of claim 1, further comprising:
logic to modify one or more authorizations of a person or persons in the area or areas according to an ingress and/or egress of at least one other person, device, and/or object to or from the area or areas.

7. A system comprising:
logic to actively detect contents of an area or areas, and to update one or more displays proximate to one or more entrances to the area or areas with indications of the contents.

8. The system of claim 7, wherein the logic to actively detect contents of an area or areas, and to update one or more displays proximate to one or more entrances to the area or areas with indications of the contents further comprises:
logic to update the one or more displays with names and/or titles of people in the area or areas.

9. The system of claim 7, wherein the logic to actively detect contents of an area or areas, and to update one or more displays proximate to one or more entrances to the area or areas with indications of the contents further comprises:
logic to update the one or more displays with at least one of roles or functions of a person or persons in the area or areas.

10. The system of claim 7, wherein the logic to actively detect contents of an area or areas, and to update one or more displays proximate to one or more entrances to the area or areas with indications of the contents further comprises:
logic to update the one or more displays with information about at least one function or purpose of one or more devices in the area or areas.

11. The system of claim 7, wherein the logic to actively detect contents of an area or areas, and to update one or more displays proximate to one or more entrances to the area or areas with indications of the contents further comprises:
logic to update the one or more displays at least in part according to access rights of a person or persons proximate with, approaching, or making contact with an ingress point or points to the area or areas.

12. The system of claim 7, further comprising:
logic to control ingress and/or egress to and/or from the area or areas at least in part according to the contents.

13. The system of claim 12, wherein the logic to authenticate the person or persons further comprises:
logic to vary the manner of authentication, or to forgo authentication, at least in part according to contents of the area or areas.

14. The system of claim 11, wherein the logic to identify a person or persons proximate with, approaching, or making contact with an ingress point or points to the area or areas, or a region or regions proximate thereto further comprises:
logic to communicate with one or more wireless telephones of the person or persons.

15. The system of claim 7, further comprising:
logic to vary the content of the display or displays at least in part according to who is proximate with and/or approaching ingress and/or egress points to the area or areas.

16. A system comprising:
logic to authorize one or more activities for a person or persons in an area or areas, at least in part according to one or more other people and/or devices identified in the area or areas.

17. The system of claim 16, wherein the logic to authorize one or more activities for a person or persons in an area or areas, at least in part according to one or more other people and/or devices identified in the area or areas further comprises:
logic to restrict the person or persons to use of particular devices within the area or areas, and/or particular functions of particular devices.

18. The system of claim 17, wherein the logic to restrict activities to at least one sub-area of the area or areas further comprises:
logic to monitor a location or locations of the person or persons in the area or areas.

19. The system of claim 16, wherein the logic to authorize one or more activities for a person or persons in an area or areas, at least in part according to one or more other people and/or devices identified in the area or areas further comprises:
logic to communicate to one or more devices in the area or areas information about one or more functions of the one or more devices that the person or persons may access.

20. The system of claim 16, wherein the logic to authorize one or more activities for a person or persons in an area or areas, at least in part according to one or more other people and/or devices identified in the area or areas further comprises:
logic to cause at least one device in the area or areas to become disabled if the person or persons become proximate with the device.

21. The system of claim 16, further comprising:
logic to modify one or more authorizations of a person or persons in the area or areas according to an ingress and/or egress of at least one other person, device, and/or object to or from the area or areas.
